(19) United States
(12) Patent Application Publication
(10) Pub. No.: US 2023/0382151 A1
(43) Pub. Date: Nov. 30, 2023

(54) MICROCUT PATTERNED TRANSFER ARTICLES

(71) Applicant: 3M INNOVATIVE PROPERTIES COMPANY, St. Paul, MN (US)

(72) Inventors: Raymond P. Johnston, Lake Elmo, MN (US); Kevin W. Gotrik, Hudson, WI (US); Graham M. Clarke, Woodbury, MN (US); John J. Sullivan, Hudson, WI (US); Matthew C. Messina, Maplewood, MN (US); Scott J. Jones, Woodbury, MN (US)

(21) Appl. No.: 18/033,429

(22) PCT Filed: Nov. 30, 2021
(86) PCT No.: PCT/IB2021/061129

§ 371 Date: Apr. 24, 2023

Related U.S. Application Data
(60) Provisional application No. 63/120,653, filed on Dec. 2, 2020.

(51) Int. Cl. B44C 1/10; B44F 1/02; B44C 1/14

(52) U.S. Cl. CPC B44C 1/105; B44F 1/02; B44C 1/14

(57) ABSTRACT

A transfer article includes a carrier layer releasable at a release value of from 2 to 50 grams/inch from a release layer including a metal layer or a doped semiconductor layer. A functional layer overlies the carrier layer, and the functional layer includes at least one microcut inorganic layer. The microcut inorganic layer includes a pattern of cut toolmarks and plates bounded by the toolmarks, wherein each of the plates has a thickness of about 3 nanometers to about 2000 nanometers. The transfer article has a thickness of less than 3 micrometers.

### BACKGROUND

Sputtering is a high-precision vacuum deposition process that can deposit inorganic thin films with single digit nanometer thickness control across large areas, and can be suitable for roll-to-roll manufacturing. Sputtering can be used to deposit stacks of inorganic thin film layers such as, for example, metal layers and metal oxide layers, on a substrate. Materials, thicknesses and the order of arrangement of the thin film inorganic layers with different indices of refraction can be selected to fine-tune the aesthetic appearance and transmissive properties of an article. For example, an article with stacks of multiple metal and metal oxide layers can appear to have different colors when viewed at a different viewing angles.

Articles including stacks of thin film inorganic layers sputter-deposited on a substrate can have a very desirable aesthetic appearance. However, when the articles are applied to a surface, particularly a surface with compound curvature, the metal layers can be stretched or strained, which can form visible crack-like defects that undesirably alter the desired aesthetic or light management properties of the article. If the metal layers, the substrate on which the metal layers are applied, or both, are made of more stretchable materials, when the article is applied to a surface the metal layers are thinned in certain areas, which can cause an undesirable change in the appearance or light management performance of the article.

### SUMMARY

In general, the present disclosure is directed to transfer articles including a dimensionally stable, yet flexible, transfer substrate having thereon a functional layer including at least one very thin film inorganic layer. In some examples, the inorganic layers in the functional layer of the transfer article are formed by a sputtering process and have a thickness of about 3 nanometers (nm) to about 2000 nm. The transfer article containing the stable transfer substrate and at least one thin inorganic layer is subsequently contacted by a microstructured tool to form in the inorganic layer a pattern of cut toolmarks faithfully corresponding to the pattern of the cutting edges of the tool. The precise pattern of toolmarks forms a first array of plates between the toolmarks, and interconnected boundary regions between the toolmarks form a corresponding second array that is an inverse of the first array.

In some example embodiments, the microcut inorganic layers articles of the present disclosure provide transferrable conductive layers with a thickness of about 1 micron, which can be used as touch sensors or antennas for a wide range of applications such as 5G. In some example embodiments, the microcut inorganic layers provide a thin line conductive mesh material that can be manufactured without multiple post-plating steps. In another example embodiment, the transfer article including the microcut inorganic layer, which is diffusely reflective, is stretched in at least one dimension and applied to a non-planar or structured surface. The network of plates and interspersed boundary regions in the microcut inorganic layer expand in varying amounts as necessary to accommodate the stretching and straining during the application process and conform to the surface. Once applied to the surface, the transfer article forms a microcut article with a precise arrangement of plates that are sufficiently small to provide tunable reflectivity performance with consistent color and a mirror-like aesthetic appearance at a selected viewing angle with respect to a major surface thereof.

Since the pattern of cut toolmarks in the microcut inorganic layer is a faithful reproduction of the pattern on the microstructured tool, the precise arrangement of plates and boundary regions make it possible to more accurately control the aesthetic appearance and conductivity of an article including stacks of inorganic materials when the article is stretched in one or more directions and applied on or adhesively bonded to a compound surface to form a laminate article. Microcutting the inorganic layer can also render the inorganic layer transmissive to electromagnetic signals within a desired frequency range, which can make the article useful in communication devices.

In one embodiment, the transfer article including the transfer substrate having a functional layer thereon includes at least one very thin film inorganic layer is transferred to a low modulus substrate having a modulus range of about 50 MPa to about 1000 MPa. While on the low modulus substrate, at least one inorganic layer in the stack of inorganic thin film layers is pattern precisely microcut against a tool. Transferring the inorganic thin layers to the low modulus substrate reduces the pressure needed to complete the patterning process, and increases the resolution of the toolmarks such that the toolmarks and interspersed plates appear unresolvable to a human eye at normal viewing distances.

In one aspect, the present disclosure is directed to a transfer article that includes a carrier layer releasable at a release value of from 2 to 50 grams/inch from a release layer including a metal layer or a doped semiconductor layer; and a functional layer overlaying the carrier layer, wherein the functional layer includes at least one microcut inorganic layer. The microcut inorganic layer includes a pattern of cut toolmarks and plates bounded by the toolmarks, wherein each of the plates has a thickness of about 3 nanometers to about 2000 nanometers. The transfer article has a thickness of less than 3 micrometers.

In another aspect, the present disclosure is directed to a method for making a patterned article. The method includes removing a transfer article from a release layer chosen from a metal layer or a doped semiconductor layer. The transfer article includes a carrier layer overlaying the release layer, wherein a release value between the release layer and the carrier layer is from 2 to 50 grams/inch, and a functional layer overlaying the carrier layer. The functional layer includes comprises at least one inorganic layer. The method further includes contacting the carrier layer with a microstructured tool with at least one cutting edge, wherein the tool forms a pattern of cuts in the at least one inorganic layer, and the pattern of cuts forms a corresponding pattern of plates in the inorganic layer, wherein each of the plates has a thickness of about 3 nanometers to about 2000 nanometers, and wherein the patterned article has a thickness of less than 3 micrometers.

In another aspect, the present disclosure is directed to an article including a first acrylate layer, and a functional layer with a first major surface on the first acrylate layer. The functional layer includes a stack of metal layers and metal oxide layers, wherein at least one of the metal layers has a pattern of cuts forming a corresponding pattern of discrete plates bounded by the cuts, and wherein the precision cut metal layer is about 5 nanometers to about 100 nanometers thick. A second acrylate layer is on a second major surface of the functional layer. A first adhesive layer on the first acrylate layer, and a first polymeric film layer on the first adhesive layer. A second adhesive layer is on the second acrylate layer, wherein the second adhesive layer is optically clear, and a second polymeric film layer is on the second adhesive layer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic cross-sectional view of an embodiment of a transfer article according to the present disclosure.

FIG. 2 is a schematic cross-sectional view of the transfer article of FIG. 1 on an adhesive layer.

FIG. 3 is a schematic representation of a roll-to-roll patterning process suitable for patterning the articles of the present disclosure.

FIG. 4A is a schematic overhead view of an embodiment of a microcut surface of an inorganic layer of an article of the present disclosure.

FIG. 4B is a cross-sectional view of the article of FIG. 4A.

FIG. 5 is a schematic overhead view of an embodiment of a microcut surface of an inorganic layer of an article of the present disclosure.

FIG. 6 is a schematic overhead view of an embodiment of a microcut surface of an inorganic layer of an article of the present disclosure.

FIG. 7 is a photograph of a matte article formed according to Comparative Example 4.

FIG. 8 is a photograph of a specular article formed according to Example 4.

Like symbols in the drawings indicate like elements.

### DETAILED DESCRIPTION

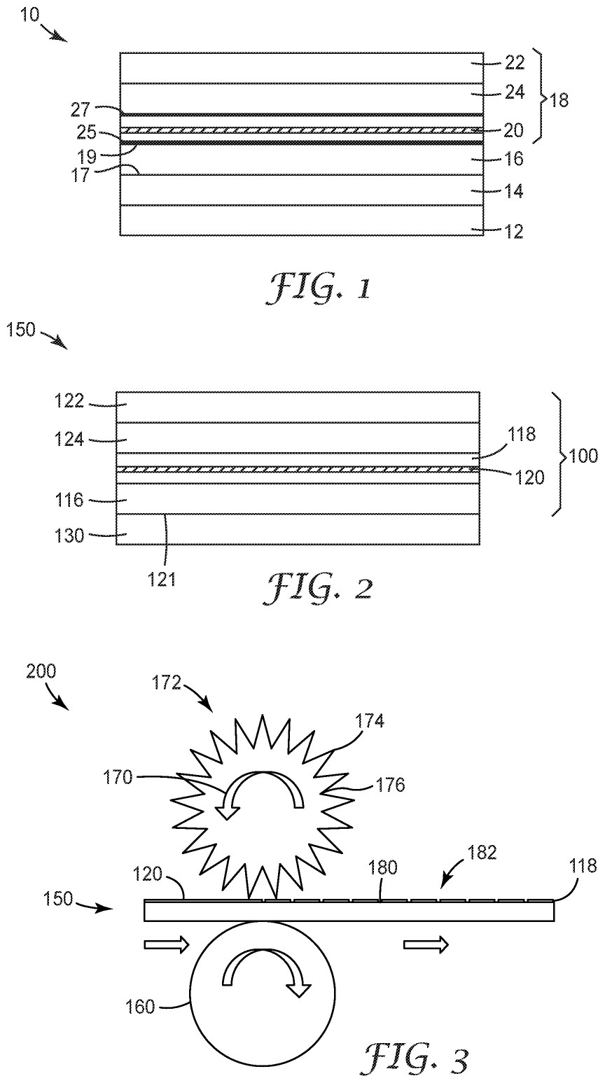

Referring to FIG. 1, a transfer article 10 includes an optional release layer substrate 12 overlain with a release layer 14. A carrier layer 16 contacts the release layer 14 along a release surface 17. A functional layer 18 includes a first major surface 19 contacting the carrier layer 16. In various embodiments, the functional layer 18 can include a stack of one or more layers selected to provide the transfer article 10 with some functional property including, but not limited to, aesthetic properties, reflective or transmissive properties, environmental properties, antimicrobial properties, and the like. The functional layer 18 includes at least one inorganic layer 20, which may be located at any point within the functional layer 18, and in some embodiments may include one or more organic layers interspersed with the at least one inorganic layer 20.

In the embodiment of FIG. 1, the functional layer 18 includes a polymeric film layer 24, which may be the same or different from the carrier layer 16. In the embodiment of FIG. 1, an optional adhesive layer 22 overlies the polymeric film layer 24 (if present). In some examples, the optional adhesive layer 22 may be used to attach the transfer article 10 to a surface of interest, or to another article (not shown in FIG. 1).

In various embodiments, the combination of the carrier layer 16 and the functional layer 18 has a thickness of less than about 3 micrometers, or less than 2 micrometers, or less than 1 micrometer, or less than 0.5 micrometers, or less than 0.25 micrometers, or less than 0.1 micrometers.

The optional release layer substrate 12 can include any material capable of supporting the release layer 14, and suitable examples include, but are not limited to, polymeric materials and metals. In some embodiments, the release layer substrate 12 can be heat-shrinkable, and can shrink at a predetermined temperature. Suitable release layer substrates 12 can be chosen from any organic polymeric layer that is processed to be heat-shrinkable by any suitable means. In one embodiment, the release layer substrate 12 is a semicrystalline or amorphous polymer that can be made heat-shrinkable by orienting at a temperature above its glass transition temperature, Tg, and then cooling. Examples of useful semicrystalline polymeric films include, but are not limited to, polyolefins such as polyethylene (PE), polypropylene (PP), and syndiotactic polystyrene (sPS); polyesters such as polyethylene terephthalate (PET), polyethylene napthalate (PEN), and polyethylene-2,6-naphthalate; fluorpolymers such as polyvinylidene difluoride, and ethylene:tetrafluoroethylene copolymers (ETFE); polyamides such as Nylon 6 and Nylon 66; polyphenylene oxide, and polyphenylene sulfide. Examples of amorphous polymer films include polymethylmethacrylate (PMMA), polyimides (PI), polycarbonate (PC), polyether sulfone (PES), atactic polystyrene (aPS), polyvinyl chloride (PVC), and norbornene based cyclic olefin polymer (COP) and cyclic olefin copolymer (COC). Some polymer materials are available in both semicrystalline and amorphous forms. Semicrystalline polymers such as those listed above can also be made heat-shrinkable by heating to the peak crystallization temperature and cooling.

In some embodiments, biaxially or uniaxially oriented polyethylene terephthalate (PET) with a thickness of approximately 0.002 inch (0.05 mm) is considered a convenient choice for the release layer substrate 12, as is biaxially oriented polypropylene (BOPP) film. Biaxially oriented polypropylene (BOPP) is commercially available from several commercial suppliers including, for example: ExxonMobil Chemical Company, Houston, TX; Continental Polymers, Swindon, UK; Kaisers International Corporation of Taipei City, Taiwan and PT Indopoly Swakarsa Industry (ISI) of Jakarta, Indonesia.

In various example embodiments, the release layer 14 can include a metal layer or a doped semiconductor layer. In the embodiment shown in FIG. 1, the carrier layer 16 is in direct contact with the release layer 14 and the functional layer 18. In the embodiment shown in FIG. 1, the optional release layer substrate 12 is in direct contact with the release layer 14, but in other embodiments there can be additional layers between the release layer substrate 12 and the release layer 14 (not shown in FIG. 1).

In some embodiments, a release value between the release layer 14 and the carrier layer 16 along the release surface 17 is less than 50 g/inch (20 g/cm), 40 g/inch (16 g/cm), 30 g/inch (12 g/cm), 20 g/inch (8 g/cm), 15 g/inch (6 g/cm), 10 g/inch (4 g/cm), 9 g/inch (3.5 g/cm), 8 g/inch (3 g/cm), 7 g/inch (2.8 g/cm), 6 g/inch (2.4 g/cm), 5 g/inch (2 g/cm), 4 g/inch (1.6 g/cm) or 3 g/inch (1.2 g/cm). In some embodiments, the release value between the release layer 14 and the carrier layer 16 is more than 1 g/inch, 2 g/inch, 3 g/inch or 4 g/inch. In some embodiments, the release value between the release layer 14 and the carrier layer 16 is from 1 to 50 g/inch, from 1 to 40 g/inch, from 1 to 30 g/inch, from 1 to 20 g/inch, from 1 to 15 g/inch, from 1 to 10 g/inch, from 1 to 8 g/inch from 2 to 50 g/inch, from 2 to 40 g/inch, from 2 to 30 g/inch, from 2 to 20 g/inch, from 2 to 15 g/inch, from 2 to 10 g/inch, or from 2 to 8 g/inch.

The transfer article 10 can be used to transfer the carrier layer 16 and the functional layer 18 thereon, so that the release layer 14 and/or the release layer substrate 12 can be reused. In one example, the transfer article 10 can be applied to a surface of interest with the functional layer 18 being between the carrier layer 16 and the surface of interest. After the transfer article 10 is applied to the surface of interest, the release layer 14 and the substrate 12, if present, can be removed from the transfer article 10. The carrier layer 16 and the functional layer 18 then remain on the surface of interest. In some embodiments, the optional adhesive layer 22 can help the functional layer 18 more effectively attach to the surface of interest.

In some embodiments, the release layer 14 can include a metal layer chosen from individual elemental metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof. In some embodiments, which are not intended to be limiting, the release layer 14 may conveniently be formed of Al, Zr, Cu, NiCr, NiFe, Ti, or Nb, and may have a thickness between about 3 nm and about 3000 nm.

In some embodiments, the release layer 14 can include a doped semiconductor layer. In some embodiments, which are not intended to be limiting, the doped semiconductor layer may conveniently be formed of Si, B-doped Si, Al-doped Si, P-doped Si with thicknesses between about 3 nm to about 3000 nm. A particularly suitable doped semiconductor layer for the release layer 14 is Al-doped Si, wherein the Al compositional percentage is about 10%.

In various example embodiments, the release layer 14 is prepared by evaporation, reactive evaporation, sputtering, reactive sputtering, chemical vapor deposition, plasma enhanced chemical vapor deposition, and atomic layer deposition

The carrier layer 16 can be made from any material that releases easily from the release layer 14, and in various embodiments can include, for example, silicones, fluorinated materials, acrylates, acrylamides, and mixtures and combinations thereof. In some embodiments, the carrier layer 16 can includes an acrylate or an acrylamide. The acrylates and acrylamides can be formed by a wide variety of techniques including flash evaporation of the monomer, vapor deposition, followed by crosslinking, of volatilizable acrylate and methacrylate (referred to herein as “(meth)acrylate”) or acrylamide or methacrylamide (referred to herein as “(meth)acrylamide”) monomers are useful, with volatilizable acrylate monomers being preferred. In various embodiments, a suitable (meth)acrylate or (meth)acrylamide monomer has sufficient vapor pressure to be evaporated in an evaporator and condensed into a liquid or solid coating in a vapor coater, deposited as a spin-on coating, and the like.

Examples of suitable monomers include, but are not limited to, hexanediol diacrylate; ethoxyethyl acrylate; cyanoethyl (mono)acrylate; isobornyl (meth)acrylate; octadecyl acrylate; isodecyl acrylate; lauryl acrylate; beta-carboxyethyl acrylate; tetrahydrofurfuryl acrylate; dinitrile acrylate; pentafluorophenyl acrylate; nitrophenyl acrylate; 2-phenoxyethyl (meth)acrylate; 2,2,2-trifluoromethyl (meth)acrylate; diethylene glycol diacrylate; triethylene glycol di(meth)acrylate; tripropylene glycol diacrylate; tetraethylene glycol diacrylate; neo-pentyl glycol diacrylate; propoxylated neopentyl glycol diacrylate; polyethylene glycol diacrylate; tetraethylene glycol diacrylate; bisphenol A epoxy diacrylate; 1,6-hexanediol dimethacrylate; trimethylol propane triacrylate; ethoxylated trimethylol propane triacrylate; propylated trimethylol propane triacrylate; tris(2-hydroxyethyl)-isocyanurate triacrylate; pentaerythritol triacrylate; phenylthioethyl acrylate; naphthloxyethyl acrylate; neopentyl glycol diacrylate, MIRAMER M210 (available from Miwon Specialty Chemical Co., Ltd., Korea), KAYARAD R-604 (available from Nippon Kayaku Co., Ltd., Tokyo, Japan), epoxy acrylate under the product number RDX80094 (available from RadCure Corp., Fairfield, N.J.); and mixtures thereof. A variety of other curable materials can be included in the polymer layer, such as, e.g., vinyl ethers, vinyl napthalene, acrylonitrile, and mixtures thereof.

Tricyclodecane dimethanol diacrylate can be used as an acrylate material for any of the component layers in the functional layer, and in some embodiments may be applied by, e.g., condensed organic coating followed by UV, electron beam, or plasma initiated free radical polymerization. In some examples, the carrier layer 16 has a thickness between about 10 nm and 10000 nm, or between about 10 nm and 5000 nm, or between about 10 nm and 3000 nm.

The polymeric film layer 24 may include any polymeric material, and may be the same or different from the carrier layer 16. In some embodiments, the polymeric film layer 24 is an acrylate or an acrylamide, and may be selected from any of the materials described above as suitable for the carrier layer 16.

In some embodiments, the functional layer 18 is an aesthetic optical layer that can have reflective, anti-reflective, partially absorbing, polarizing, retarding, diffractive, scattering, or transmissive properties over electromagnetic wavelengths of interest. The functional layer includes at least one or a plurality of inorganic layers 20, which in various embodiments include metal layers and metal oxide layers, which may have the same or different thicknesses and indices of refraction chosen to provide a predetermined optical effect over the electromagnetic wavelengths of interest.

In various embodiments, the functional layer 18 has a thickness of less than about 5 microns, or less than about 2 microns, or less than about 1 micron, or less than about 0.5 microns.

In various embodiments, which are not intended to be limiting, the inorganic layer 20 in the functional layer 18 can include a metal chosen from individual elemental metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof. In some embodiments, which are not intended to be limiting, the inorganic layer 20 is chosen from Ag, Al, Ge, Au, Si, Ni, Cr, Co. Fe, Nb, and mixtures, alloys and oxides thereof. In some embodiments, the inorganic layer 20 of the functional layer 18 includes layers of metal oxides such as, for example, SiAlOx, NbOx, and mixtures and combinations thereof, which are interspersed with the metal layers.

In some embodiments, the inorganic layer or layers 20 are applied by sputtering, evaporation, or flash evaporation, and a thickness between about 3 and about 200 nm, or about 3 to about 100 nm, or about 3 nm to about 50 nm, or about 3 nm to about 20 nm, or about 3 nm to about 15 nm, or about 3 nm to about 10 nm, or about 3 nm to about 5 nm.

In some embodiments, the functional layer 18 includes a stack of a plurality of metal layers, wherein at least some of the metal layers in the stack are separated by metal oxide layers, polymeric layers, or mixtures and combinations thereof. In various embodiments, each metal layer in the stack can have substantially the same thickness, or the metal layers in the stack can have different thicknesses. In some embodiments, which are not intended to be limiting, each inorganic layer in the plurality of inorganic layers has a thickness of about 5 nm to about 100 nm. In various embodiments, the stack of inorganic layers can include about 2 to about 100 layers, or about 2 to 10, or about 2 to 5.

In one example embodiment, the functional layer 18 includes a plurality of inorganic layers, including metal or metal oxide layers, which may be the same or different, and may have the same or different thicknesses, separated by acrylate layers. In some embodiments, the acrylate layers in the functional layer 18 may be the same or different from the carrier layer 16 and the polymeric film layer 24 in the transfer article, may have the same or different thicknesses.

In some embodiments, the functional layer 18 can include one or more optional barrier layers 25, 27 along the major surfaces 19, 21 thereof as shown schematically in FIG. 1, or on exposed surfaces of the inorganic layer 20, or both. The one or more barrier layers 25, 27 may include individual elemental metals, two or more metals as mixtures, inter-metallics or alloys, semi-metal or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof.

In some embodiments, the barrier layers 25, 27 may be chosen from metal oxides, metal nitrides, metal oxy-nitrides, and metal alloys of oxides, nitrides and oxy-nitrides. In some embodiments, the barrier layers 15, 27 may include a metal oxide chosen from silicon oxides such as silica, aluminum oxides such as alumina, titanium oxides such as titania, indium oxides, tin oxides, indium tin oxide (ITO), hafnium oxide, tantalum oxide, zirconium oxide, zinc oxide, niobium oxide, and combinations thereof. In some embodiments, the metal oxides for the barrier layers 25, 27 may include aluminum oxide, silicon oxide, silicon aluminum oxide, aluminum-silicon-nitride, and aluminum-silicon-oxy-nitride, CuO, TiO₂, ITO, ZnO, aluminum zinc oxide, ZrO₂, and yttria-stabilized zirconia. Preferred nitrides may include Si₃N₄ and TiN.

In some example embodiments, the barrier layers 25, 27 can typically be prepared by reactive evaporation, reactive sputtering, chemical vapor deposition, plasma enhanced chemical vapor deposition, and atomic layer deposition. Preferred methods include vacuum preparations such as reactive sputtering and plasma enhanced chemical vapor deposition, and atomic layer deposition.

The barrier layers 25, 27 can be conveniently applied as a thin layer. The barrier layer material, e.g. silicon aluminum oxide, can for example, provide good barrier properties, as well as good interfacial adhesion to the other layers in the stack such as, for example, acrylate layers. Such layers are conveniently applied by sputtering, and a thickness between about 3 and 100 nm is considered convenient, with approximately 27 nm in thickness being considered particularly suitable. In some embodiments, the barrier layer may have a water vapor transmission rate of less than 0.2, 0.1, 0.05, 0.01, 0.005 or 0.001 g/m²/day, thus providing good environmental resistance for the inorganic layer 20.

The optional adhesive layer 22 on the transfer article 10 can include a viscoelastic or elastomeric adhesive with a low modulus of 50 MPa to about 1000 MPa. or about 100 MPa to about 500 MPa. Suitable viscoelastic or elastomeric adhesives can include those described in U.S. Pat. App. Pub. No. 2016/0016338 (Radcliffe et al.), for example, pressure-sensitive adhesives (PSAs), rubber-based adhesives (e.g., rubber, urethane) and silicone-based adhesives. Viscoelastic or elastomeric adhesives also include heat-activated adhesives which are non-tacky at room temperature but become temporarily tacky and are capable of bonding to a substrate at elevated temperatures. Heat activated adhesives are activated at an activation temperature and above this temperature have similar viscoelastic characteristics as PSAs. Viscoelastic or elastomeric adhesives may be substantially transparent and optically clear.

Any of the viscoelastic or elastomeric adhesives 22 may be viscoelastic optically clear adhesives. Elastomeric materials may have an elongation at break of greater than about 20 percent, or greater than about 50 percent, or greater than about 100 percent.

The viscoelastic or elastomeric adhesive layers 22 may be applied directly as a substantially 100 percent solids adhesive or may be formed by coating a solvent-borne adhesive and evaporating the solvent. Viscoelastic or elastomeric adhesives may be hot melt adhesives which may be melted, applied in the melted form and then cooled to form a viscoelastic or elastomeric adhesive layer. Suitable viscoelastic or elastomeric adhesives include elastomeric polyurethane or silicone adhesives and the viscoelastic optically clear adhesives CEF22, 817×, and 818×, all available from 3M Company, St. Paul, MN. Other useful viscoelastic or elastomeric adhesives include PSAs based on styrene block copolymers, (meth)acrylic block copolymers, polyvinyl ethers, polyolefins, and poly(meth)acrylates. In some embodiments, the adhesive layer 22 can include a UV cured adhesive.

Referring again to FIG. 1, the carrier layer 16 may be removed from the release layer 14 along the release surface 17. The resulting transfer article 100, which in the embodiment of FIG. 2 includes the carrier layer 116, the functional layer 118 with the at least one inorganic layer 120, the polymeric film layer 124, and the adhesive layer 122, forms a patternable construction 150 (FIG. 2). In some embodiments, a surface 121 of the carrier layer 116, which is air-facing following removal from the release layer 14, can be contacted with a tool to change the shape of the at least one inorganic layer 120. In some embodiments, depending on the materials and the thicknesses selected for the inorganic layer 120 in the functional layer 118, the carrier layer 116 may not be required to support the functional layer 118, and the functional layer 118 may be contacted with the tool to change the shape of the at least one inorganic layer 120. The relatively soft low modulus adhesive layer 122 underlying the carrier layer 116 (if present), or the functional layer 118, allows for lower pressures during the process of patterning the at least one inorganic layer 120.

In another embodiment, following the transfer the carrier layer 116 is applied on an intermediary substrate prior to the patterning step. For example, as shown in FIG. 2, the carrier layer 116 may be applied to a low modulus layer 130 such that the carrier layer 116 contacts the low modulus layer 130 to create a patternable construction 150. The low modulus layer 130 can include any material with a modulus at of about 50 MPa to about 1000 MPa, or about 100 MPa to about 500 MPa. In some embodiments, the low modulus layer 130 is an adhesive layer, which in some embodiments may be a pressure sensitive adhesive, a bonding adhesive, and the like. In various embodiments, the low modulus layer 130 is an acrylic adhesive or an acrylic pressure sensitive adhesive.

In various embodiments, the article 150 of FIG. 2 may optionally include polymeric film layers on one or both of the adhesive layer 122 and the low modulus layer 130 (not shown in FIG. 2).

The patternable construction 150 of FIG. 2, with or without the low modulus layer 130, may be contacted with a microstructured tool to change the shape of at least one inorganic layer 120. The patternable construction 150 may be contacted with the tool in using a wide variety of techniques including, for example, rotary cutting, single nip cutting, spot cutting, overall cutting, engraving, microcutting, and the like. In some embodiments, which are not intended to be limiting, the patternable construction 150 is contacted with a rotary cutting tool with a plurality of cutting edges.

For example, as shown schematically in FIG. 3, in a process 200 the patternable construction 150 is translated in a direction A, passed over a roller 160, and contacted with a microstructured rotary cutting tool 170. In various embodiments, the roller 160 may itself be driven or undriven. In various example embodiments, the roller 160 is a rigid material such as steel, or may also be a compliant material such as rubber or polymeric material.

The cutting tool 170 includes a pattern 172 with a plurality of cutting edges 174. The cutting edges 174 extend outward from a surface 176 on the cutting tool 170 and cut into the functional layer 118 to form and form a pattern 180 of cut toolmarks 182. In some embodiments, the toolmarks 182 are cut lines formed in at least one inorganic layer 120 of the functional layer 118.

The shapes and arrangements of the cutting edges 174 on the cutting tool 170 may vary widely, and the shapes of the cut toolmarks 182 in the inorganic layer 120 are a faithful reproduction of the shapes and arrangements of the cutting edges 174. In various embodiments, the cut toolmarks may be arranged in a regular or an irregular array on the surface 176 of the tool 170, and likewise the toolmarks formed by the cutting edges 174 may be located throughout the inorganic layer 120, or in specific regions of the inorganic layer 120, and some areas of the inorganic layer may be free of toolmarks.

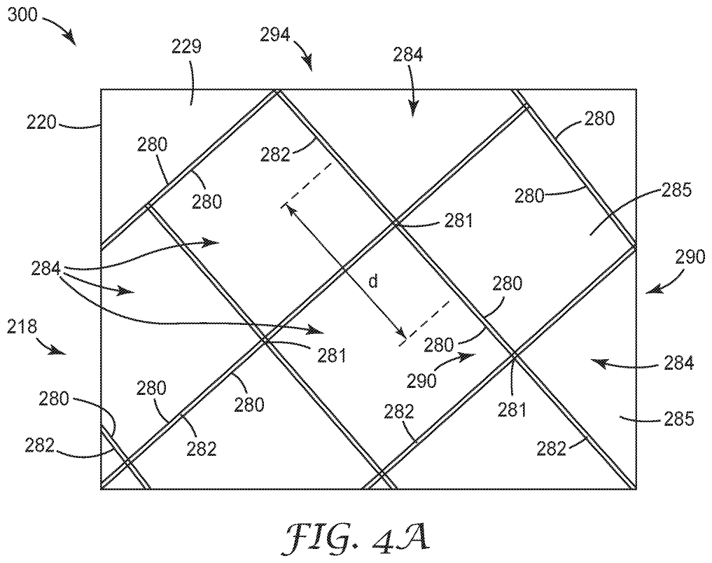

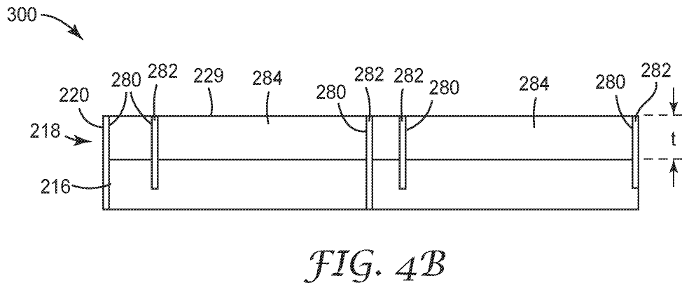

Referring now to FIG. 4A, an overhead view of a portion of an embodiment of a transfer article 300 includes a patterned inorganic layer 220 with a major surface 229 that has been processed by a tool to form a pattern 290 of discrete cuts 280. The cuts 280 can have any desired shape derived from the shapes of the cutting edges of the tool, but in the embodiment of FIG. 4A have a linear shape, and are arranged in substantially parallel lines. Each pair of cuts 280 is terminated at opposed ends by a termination region 281. In various embodiments, the cuts 280 are present on the surface 229 at about 0.3 to about 2000 per mm², or about 1 to about 1000 per mm², or about 10 to about 500 per mm², or about 50 to about 100 per mm².

The parallel cuts 280 are separated by discrete boundary regions 282, which form a discontinuous regular array 292 on the surface 229. While the boundary regions 282 are discrete and separated at their intersections by the termination regions 281, in some embodiments the boundary regions 282 may be sufficiently contiguous with each other to form an electrically conductive mesh-like web on the surface 229. In various embodiments, the boundary regions 282 may occupy from about 1% to about 99.9% of the surface 229, or about 10% to about 90%.

The cut lines 280 bound plates 284, which form a discontinuous regular array 294 on the surface 229. The shapes of the plates 284 may vary widely depending on the shapes of the cutting edges of the tool used to form the cuts 280, and may be regular as shown in FIG. 4A, or irregular. In the embodiment of FIG. 4A, the plates 284 are discrete structures, but the shape and dimensions of the plates vary widely depending on the configuration of the cutting tool used to form the cut lines 280. For example, if the parallel cut lines 280 do not cross over each other, the plates can be large structures extending in some patterns to the edge of the surface 229.

In the example embodiment of FIG. 4A, the plates 284 are shaped like a rectangular solid, and may have any an average center-to-center spacing d of less than about 2000 microns, or less than about 500 microns, or less than about 250 microns, or less than about 150 microns, or less than about 100 microns. In some embodiments, the plates 284 have larger dimensions in an x-y plane of the inorganic layer than in a z-direction normal to the x-y plane of the inorganic layer, but such an arrangement is not required. In various embodiments, the plates 284 may occupy from about 1% to about 99.9% of the surface 229, or about 10% to about 90%. In various embodiments, the exposed surfaces 285 of the plates 284 may be substantially flat, or may be contoured.

In some embodiments (not shown in FIG. 4A), exposed surfaces of the plates 284, or other portions of the surface 229, or both, may include a microstructured pattern superimposed thereon. In one example embodiment, the pattern can include toolmarks with a period of less than about 750 microns. In various embodiments, the plates 284 may occupy substantially the same plane, or may reside in different or varying planes.

Referring now to FIG. 4B, a cross-sectional view of the article 300 of FIG. 4A includes a carrier layer 216 underlying a functional layer 218 with a patterned inorganic layer 220 thereon (the other layers in the functional layer 218 are omitted for clarity). The inorganic layer 220, which includes a major surface 229, has a thickness t of about 1 nm to about 250 nm, or about 3 nm to about 200 nm, or about 5 nm to about 100 nm, or about 10 nm to about 50 nm. In various embodiments, the cuts 280 may extend through the full thickness t of the inorganic layer 220, may extend into the underlying carrier layer 216, or may extend through the full thicknesses of both the inorganic layer 220 and the carrier layer 216.

As shown in FIG. 4B, the surface 229 of the inorganic layer is substantially planar following the imposition of the cuts 282, and the arrays of boundary regions 282 and plates 284 in the microcut article 300 occupy substantially the same plane on the carrier layer 216.

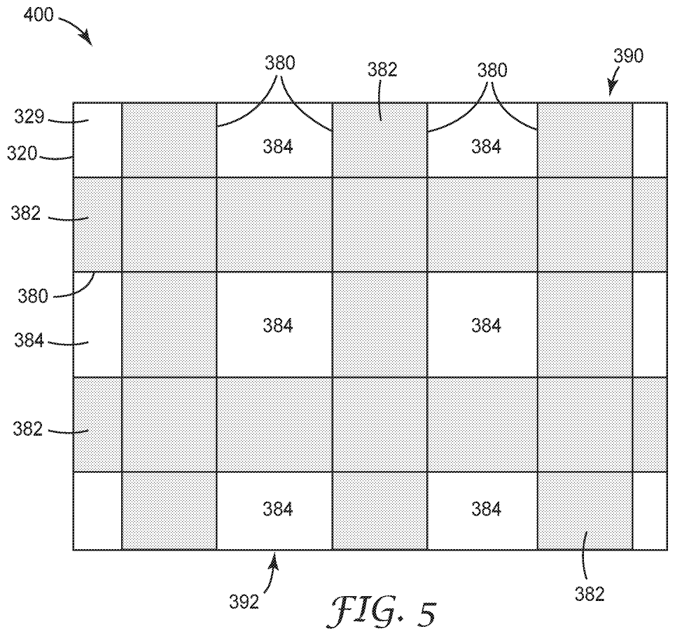

Referring to another example embodiment in FIG. 5, an overhead view of a portion of an embodiment of a transfer article 400 includes an inorganic layer 320 with a major surface 329 that has been processed by a tool to form a pattern 390 of discrete cuts 380. The cuts 380 have a linear shape, and are arranged in substantially parallel lines. Each pair of cuts 380 is terminated at opposed ends by a termination region 381. The parallel cuts 380 are separated by discrete boundary regions 382, which form a discontinuous regular array 392 on the surface 329. While the boundary regions 382 are discrete and separated by the termination regions 381, in some embodiments the boundary regions 382 may be sufficiently contiguous with each other to form an electrically conductive mesh-like web on the surface 329.

The cuts 380 bound discrete plates 384, which form a discontinuous regular array 394 on the surface 329. The shapes of the plates 384 may vary widely, and may be regular as shown in FIG. 4B, or irregular. The shapes of the plates 384 may vary widely, but as the parallel cuts 380 are made farther apart, the portion of the surface 329 occupied by the boundary regions 382 increases, and the portion of the surface occupied by the plates 384 becomes smaller, forming post-like structures on the surface 329.

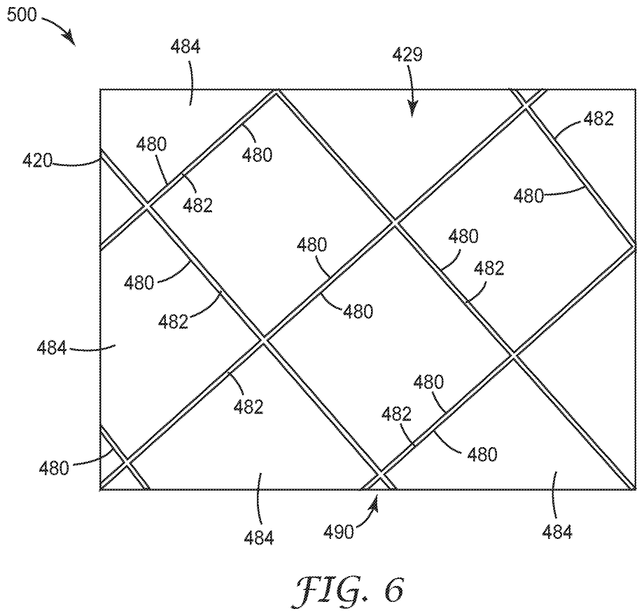

Referring now to FIG. 6, an overhead view of a portion of another embodiment of a transfer article 500 includes a patterned inorganic layer 420 with a major surface 429 that has been processed by a tool to form a pattern 490 of continuous cuts 480. The cuts 480 have a linear shape, and are arranged in substantially parallel lines that do not cross over one another. The parallel cuts 480 are separated by continuous boundary regions 482, which form a continuous regular array 492 on the surface 429. The continuous boundary regions 482 form a mesh-like web on the surface 329, which may in some cases be conductive.

The cut lines 480 bound discrete plates 484, which form a discontinuous regular array 494 on the surface 429. As noted above, the shapes of the plates 484 may vary widely, and may be regular or irregular.

In one example embodiment, if the inorganic layer 420 includes metal or metal oxide layers, the microcut articles of the present disclosure have at least one of an anti-microbial, an antibacterial, or an anti-biofilm, effect. A wide variety of metal oxides MOₓ may be used in such an application, as long as the inorganic layer 420 exhibits at least a 1-log microbial reduction, at least a 2-log reduction, at least a 3-log reduction, or at least a 4-log reduction, against S. aureus and S. mutans following 24 hour contact. Log reductions are measured after testing according to ISO test method ISO 22196:2011, “Measurement of antibacterial activity on plastics and other non-porous surfaces,” with appropriate modifications of the test method to accommodate the test materials.

Suitable antimicrobial metals and metal oxides for the inorganic layer 420 include, but are not limited to, silver, silver oxide, copper oxide, gold oxide, zinc oxide, magnesium oxide, titanium oxide, chromium oxide, and mixtures, alloys and combinations thereof. In some embodiments, which are not intended to be limiting, the metal oxide in the inorganic layer 420 is chosen from AgCuZnOx, Ag doped ZnOx, Ag doped ZnO, Ag doped TiO₂, Al doped ZnO, and TiOx.

In various embodiments, the inorganic layer 420 can include any antimicrobially effective amount of a metal, a metal oxide MOₓ, or mixtures and combinations thereof. In various embodiments, which are not intended to be limiting, the metal oxide layer 420 can include less than 100 mg, less than 40 mg, less than 20 mg, or less than 5 mg MOx per 100 cm².

In another embodiment, the inorganic layer 420 can have dielectric properties, and can be transmissive to electromagnetic signals over a selected frequency range, which can be useful in 5G communication devices. For example, if the patterned inorganic layer 420 has a tan δ of 0.12 when measured in a cavity of a split post dielectric resonator at 9.5 GHz as set forth in IPC Standard TM-650 2.5.5.13, the layer can be more transparent to communication signals transmitted between mobile devices as compared to their non-microcut state. In some embodiments, the microcut inorganic layer 420 can have a real permittivity of about 33, and a complex permittivity of about 4.

In another example, the shapes and sizes of the plates 484 and the boundary regions 482 can be configured to provide transparency for near infrared signals, which can enable the formation of highly conformable near-IR sensor cover construction on a surface. In another example, plates and the crevasses and cracks interspersed therebetween can be configured to provide reflectivity for near infrared signals and transparency for visible light. For example, such a configuration can form a highly conformable visible light sensor cover.

In other examples, the shapes and sizes of the plates 484 and the boundary regions 482 can result in color changing, reflective, transmissive, or other aesthetic effects for the inorganic layer 420, which can provide a useful decorative film that may be applied to complex or compound surfaces such as, for example, vehicle exteriors or interiors. For example, in some embodiments, the transfer article including the microcut inorganic layer is reflective at visible wavelengths from 400-750 nm and at least partially transparent at wavelengths of greater than about 830 nm.

For example, when exposed to ambient conditions, some plates 484 oxidize over time, and this detectable color change can be used to evaluate, for example, a shelf life of a product. If the color change is not desirable, one or both surfaces of the microcut metal surface can be overlain by one or more protective barrier layers of, for example, a metal oxide. In another example, the metal layers can be configured such that the plates 484 provide a color-changing effect when exposed to light over a selected wavelength range such as, for example, when the article is stretched in two or three dimensions over a surface with compound curvature.

The devices of the present disclosure will now be further described in the following non-limiting examples.

### EXAMPLES

The following examples are for illustrative purposes and are not meant to be limiting to the scope of the appended claims. All parts, percentages, ratios, etc. in the example and the rest of the specification are by weight, unless noted otherwise.

TABLE 1
Materials and Sources

| Abbreviation | Description |
|---|---|
| SV480 | 3M ENVISION Print Wrap Film SV480mc, a on PVC |
| | print wrap film (0.0508 mm), was obtained from |
| | the 3M Company, Saint Paul, MN. |
| 8518 | Transparent PVC film with an adhesive coating was |
| | obtained from the 3M Company as 3M 8518 |
| | SCOTCHCAL Gloss Overlaminate, a transparent PVC |
| | film with an adhesive coating, was obtained |
| | from 3M. |
| OCA | 3M Optically Clear Adhesive 8171, an acrylic-based |
| | adhesive (0.0250 mm thick), was obtained from 3M. |
| PETG | Uncoated, clear polyethylene terephthalate glycol |
| | (0.75 mm thick) film was obtained from PACUR, LLC |
| | (Oshkosh, WI). |
| Microemboss | 3M SCOTCHLITE Reflective Material - 8987 |
| Tool 1 | Fluorescent Lime-Yellow Flame Resistant Fabric, a |
| | bead-based retroreflective surface, was obtained from |
| | 3M and used as a micro-embossing surface. The surface |
| | contained a distributed layer of randomly closed |
| | packed <100 micron glass beads. |

Microcut Tools were prepared by the following specification:

The tools were generated by diamond cutting 12 um deep trenches into a cylindrical roll using conventional machining methods. The trenches were cut in a 45 degree and a −45 degree directions relative to the circumferential direction of the roll. The pitch between the trenches was 300 um. The resultant tool was intersecting trenches that formed diamond shape raised areas, with 45 degree intersecting trenches. Half of the patterns were cut with tools that had 0.15 um tips on the edge of the diamond. The diamond edges with the tip had 60 degree included angles.

Next the pattern was removed from the roll by peeling a thin layer of copper off the cylinder surface with the trench pattern describe above. This thin copper sheet was then Ni plated using traditional Ni electroplating methods to form the negative of the cut trench pattern. The Nickel sheets electroplated from the pattern with the edge features, resulted in raised edges in the nickel sheet.

The Nickel shims were then back side ground smooth and welded together to form a roll sleeve. The sleeve was then mounted onto a temperature-controlled mandrel, and the mandrel was installed in a laminator.

TABLE 2
Pattern description

| | | | Tip | |
|---|---|---|---|---|
| Abbreviation of | | Rib side angles in | width | Edge |
| Pattern | Height | degrees (included) | (um) | features* |
| MicroCut Tool1 | 12 | 8 | 4 | No |
| MicroCut Tool2 | 12 | 8 | 4 | Yes |
| MicroCut Tool3 | 12 | 8 | 10 | No |
| MicroCut Tool4 | 12 | 8 | 10 | yes |

*Raised 0.15 um edge with 60° included angle

### Test Methods

### Micro-Cut Confirmation Test

A VHX-6000 series Keyence digital microscope with a 100× objective lens (Keyence Corporation of America, Itasca, IL) was used in visible light transmission mode to view light leakage from fractures in the film article. Fractures were visible as higher visible light transmission regions surrounded by the lower visible light transmission non-fractured surfaces.

### Preparative Example 1

### Ag Coated Transfer Stack

The transfer film of this Example was made on a roll to roll vacuum coater similar to the coater described in US 2010/0316852 with the addition of a second evaporator and curing system located between the plasma pretreatment station and the first sputtering system, and using evaporators as described in U.S. Pat. No. 8,658,248. The coater was threaded up with an indefinite length roll (980 microinch (0.0250 mm) thick, 14 inch (35.6 cm) wide) of an aluminized biaxially-oriented polypropylene film release layer (obtained under the trade designation TORAYFAN PMX2 from Toray Plastics (America), North Kingstown, RI). The release layer was then advanced at a constant line speed of 32 fpm (9.8 meters/minute).

A carrier layer, tricyclodecane dimethanol diacrylate (obtained under the trade designation SARTOMER SR833S from Sartomer USA, Exton, PA) was applied to the release layer by ultrasonic atomization and flash evaporation to make a coating width of 12.5 inches (31.8 cm). The flow of liquid monomer into the evaporator was 0.67 mL/minute. The nitrogen gas flow rate was 100 standard cubic centimeters per minute (sccm), and the evaporator temperature was set at 500° F. (260° C.). The process drum temperature was 14° F. (−10° C.). This monomeric coating was subsequently cured immediately downstream with an electron beam curing gun operating at 7.0 kV and 10.0 mA to result in a 180 nm acrylate thickness.

On top of the carrier layer, a silver reflector layer was deposited by direct current (DC) sputtering of a >99% silver cathode target. The system was operated at 3 kW with a 30 fpm (9.1 meters per minute) line speed. Two subsequent depositions with the same power and line-speed were done to create a 90 nm layer of silver.

On top of the silver layer, an oxide layer of silicon aluminum oxide was deposited by alternating current (AC) reactive sputtering. The cathode had a Si(90%)/Al(10%) target and was obtained from Soleras Advanced Coatings US (Biddeford, ME). The voltage for the cathode during sputtering was controlled by a feed-back control loop that monitored the voltage and controlled the oxygen flow. The system was operated at 32 kW of power to deposit a 12 nm thick layer of silicon aluminum oxide onto the silver reflector. Similar to the description in U.S. Application Serial Nos. 2020/0016879 and 2020/0136086, the aluminum surface of the TorayFAN PMX2 film and the first organic layer would decouple with a 180 Peel force of 7.2 g/in (0.283 g per mm).

### Preparative Example 2

### Weather-Resistant Al-based MIM Transfer Stack

The coater was threaded up with an indefinite length roll (980 microinch (0.0250 mm) thick, 14 inch (35.6 cm) wide) of an aluminized polyethylene (PET) film release layer (obtained under the trade designation TORAYFAN MT60 from Toray Plastics (America), North Kingstown, RI). The release layer with coated carrier layer was prepared according to the procedure described in the first part of Preparative Example 1. On the top of the first carrier layer, an aluminum reflector layer was deposited. A conventional DC sputtering process employing argon gas and operated at 2 kW of power was employed to deposit a 60 nm thick layer of Al. The cathode Al target was obtained from ACI Alloys (San Jose, CA).

On top of the reflective Al layer, a polymeric film layer was applied, which was a second acrylate layer produced from a monomer solution by atomization and evaporation of SARTOMER SR833S+3% CN 147 (obtained from Sartomer USA, Exton, PA). The second acrylate layer was applied using a flow rate of the mixture into the atomizer of 0.67 mL/min; a gas flow rate of 60 sccm, and an evaporator temperature of 260° C. Once condensed onto the Al layer, the coated acrylate was cured with an electron beam operating at 7 kV and 10 mA to provide a 290 nm thick layer. This second acrylate layer provided the insulating layer of the functional metal-insulator-metal (MIM) transfer stack.

On top of the second acrylate layer, a first inorganic barrier layer was applied. The oxide material of the barrier layer was applied by an AC reactive sputter deposition process employing a 40 kHz AC power supply. The cathode had a Si(90%)/Al(10%) rotary target and was obtained from Soleras Advanced Coatings US. The voltage for the cathode during sputtering was controlled by a feed-back control loop that monitored the voltage and controlled the oxygen flow. The system was operated at 16 kW of power to deposit a 12 nm thick layer of silicon aluminum oxide onto second acrylate layer.

On top of the first inorganic barrier layer, a second reflective layer was deposited in a similar manner as the first reflective layer. A conventional DC sputtering process employing argon gas and operated at 2 kW of power was employed to deposit the second reflective layer as an 8 nm thick layer of Al.

On top of the second reflective layer, a second inorganic barrier layer was applied in the same manner as the first inorganic barrier layer.

A third acrylate layer was deposited on top of the second inorganic barrier layer. This layer was produced from monomer solution by atomization and evaporation of SARTOMER SR833S+6% Dynasilan 1189 (obtained from Evonik Industries, Essen, DE). The flow rate of this mixture into the atomizer was 0.67 mL/minute. The gas flow rate was 60 sccm, and the evaporator temperature was 260° C. Once condensed onto the second inorganic barrier layer, the coated acrylate was cured with an electron beam operating at 7 kV and 10 mA to provide a 290 nm thick layer. Similar to what is described in 79204US002 and 79250US002, the aluminum surface of the Toray MT60 film and the first organic layer would decouple with a 180 Peel force of 7.2 g/in (0.283 g per mm).

### Comparative Example 1

### Transfer-Based Non-Cut Article

The adhesive surface of 8518 film was laminated to the second reflective layer surface of the transfer stack of Preparative Example 2. The TORAYFAN PMX2 release liner was removed leaving an air-facing (carrier layer out) transfer stack on the 8518 film surface. SV480 film was then laminated with a hand roller to the air-facing carrier layer.

The full construction was uniaxially stretched by hand to 30% elongation in the machine direction. Stretching broke the brittle transfer-stack construction into discrete flakes with dimensions on the order of 500 microns as measured using a digital Keyence VHX-6000 microscope equipped with a built-in software measurement tool. These large discrete flakes were discemable by visual examination under ambient light conditions at a viewing distance of 10 cm from the sample surface. The large flakes and random fracture spacing between them that was observed was not aesthetically pleasing.

### Example 1

### Transfer-Based Micro Cut Article

Preparative Example 1 was roll-to-roll laminated against MicroCutTool1 at 200 degrees F. (93° C.) and was backed by a 68 Shore A rubber laminator at 200 degrees F. (93° C.) using 40 pounds per linear inch (7.2 kg/cm) nip lamination force and 3 pounds per inch 0.5 kg/cm) input tension and 1 pound per inch (0.18 kg/cm) output (after micro cutting) tension to micro-cut the surface. The adhesive surface of 8518 film was laminated to the oxide layer of Preparative Example 1. The TORAYFAN PMX2 release liner was removed leaving an air-facing (carrier layer out) transfer stack on the 8518 film surface. The “Micro-cut Confirmation Test” confirmed that micro-cuts were present and matched the MicroCutTool1 tool edge contact regions. 4-micron wide ribbons of the deposited layers in Preparative Example 1 were observed.

### Comparative Example 2

### Transfer-Based Non Micro Cut Article

Preparative Example 2 was roll-to-roll laminated against MicroCutTool1 at 200 degrees F. and was backed by a 68 Shore A rubber laminator at 200 degrees F. using 40 pounds per linear inch nip lamination force and 3 pounds per inch (0.5 kg/cm) input tension and 1 pound per inch (0.18 kg/cm) output (after micro cutting) tension to micro-cut the surface. The adhesive surface of 8518 film was laminated to the third acrylate layer of Preparative Example 2. The TORAYFAN MT60 release liner was removed leaving an air-facing (carrier layer out) transfer stack on the 8518 film surface. The “Micro-cut Confirmation Test” confirmed that micro-cuts were not consistently present especially near the intersection of where the 45° lane cuts converge and did not substantially match the MicroCutTool2 tool edge contact regions.

### Example 2

### Transfer-Based Micro Cut Article

Preparative Example 2 was roll-to-roll laminated against MicroCutTool2 at 200 degrees F. (93° C.) and was backed by a 68 Shore A rubber laminator at 200 degrees F. (93° C.) using 40 pounds per linear inch (7.2 kg/cm) nip lamination force and 3 pounds per inch (0.5 kg/cm) input tension and 1 pound per inch (0.18 kg/cm) output (after micro cutting) tension to micro-cut the surface. The adhesive surface of 8518 film was laminated to the third acrylate layer of Preparative Example 2. The TORAYFAN MT60 release liner was removed leaving an air-facing (carrier layer out) transfer stack on the 8518 film surface. The “Micro-cut Confirmation Test” confirmed that micro-cuts were present and matched the MicroCutTool2 tool edge contact regions. 4-micron wide ribbons of the deposited layers in Preparative Example 2 were observed.

### Comparative Example 3

### Transfer-Based Non Micro Cut Article

Preparative Example 2 was roll-to-roll laminated against MicroCutTool3 at 200 degrees F. (93° C.) and was backed by a 68 Shore A rubber laminator at 200 degrees F. (93° C.) using 40 pounds per linear (7.2 kg/cm) inch nip lamination force and 3 pounds per inch (0.5 kg/cm) input tension and 1 pound per inch (0.18 kg/cm) output (after micro cutting) tension to micro-cut the surface. The adhesive surface of 8518 film was laminated to the third acrylate layer of Preparative Example 2. The Toray MT60 release liner was removed leaving an air-facing (carrier layer out) transfer stack on the 8518 film surface. The “Micro-cut Confirmation Test” confirmed that micro-cuts were not consistently present especially near the intersection of where the 45° lane cuts converge and did not substantially match the MicroCutTool3 tool edge contact regions.

### Example 3

### Transfer-Based Micro Cut Article

Preparative Example 2 was roll-to-roll laminated against MicroCutTool4 at 200 degrees F. (93° C.) and was backed by a 68 Shore A rubber laminator at 200 degrees F. (93° C.) using 40 pounds per linear inch (7.2 kg/cm) nip lamination force and 3 pounds per inch (0.5 kg/cm) input tension and 1 pound per inch (0.18 kg/cm) output (after micro cutting) tension to micro-cut the surface. The adhesive surface of 8518 film was laminated to the third acrylate layer of Preparative Example 2. The TORAYFAN MT60 release liner was removed leaving an air-facing (carrier layer out) transfer stack on the 8518 film surface. The “Micro-cut Confirmation Test” confirmed that micro-cuts were present and matched the MicroCutTool4 tool edge contact regions. 10-micron wide ribbons of the deposited layers in Preparative Example 2 were observed.

### Comparative Example 4

### Transfer-Based Micro Embossed Article

The adhesive surface of 8518 film was laminated to the second reflective layer surface of the transfer stack of Preparative Example 2. The TORAYFAN PMX2 release liner was removed leaving an air-facing (carrier layer out) transfer stack on the 8518 film surface.

The carrier layer was micro-embossed with a steel-roller-backed MicroEmboss Tool 1 and was backed by a 68 Shore A rubber laminator using 90 pounds per linear inch (16 kg/cm) nip lamination force to microemboss the surface. The micro-embossing tool film was discarded. The “Microfracture Confirmation Test” confirmed that microfractures were present in the surface tested. OCA was laminated the carrier layer. SV480 was laminated to OCA and the SV480 adhesive surface was wrapped over a 3D PETG form. Visible cracks were not human visible at 10 cm spacing. The film appeared aesthetically pleasing and matte in appearance, as shown in FIG. 7.

### Example 4. Transfer-Based Micro Cut Article

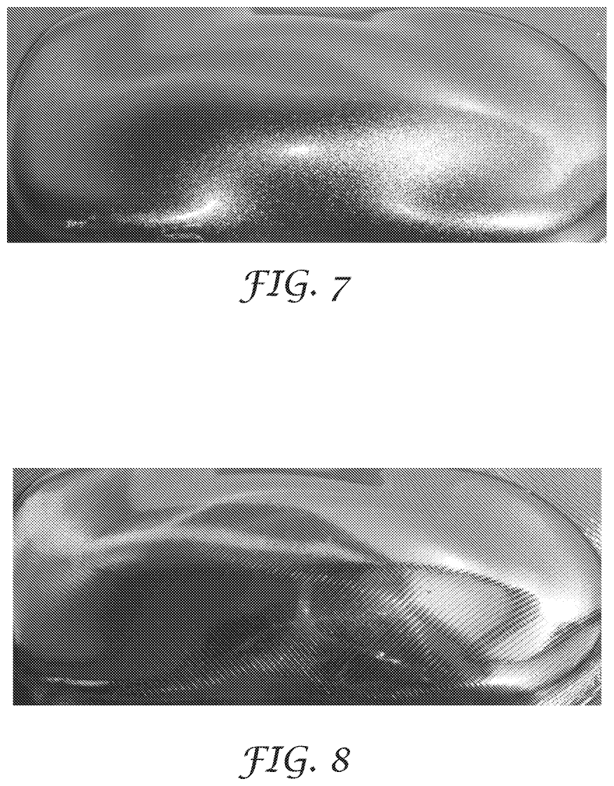

OCA was laminated the carrier layer of Example 3. SV480 was laminated to OCA and the SV480 adhesive was wrapped over a 3D PETG form. Visible micro cut lines were human visible at 10 cm spacing. The film appeared aesthetically pleasing and specular in appearance, as shown in FIG. 8.

Various embodiments of the invention have been described. These and other embodiments are within the scope of the following claims.

1. A transfer article, comprising:
a carrier layer releasable at a release value of from 2 to 50 grams/inch from a release layer comprising a metal layer or a doped semiconductor layer; and
a functional layer overlaying the carrier layer, wherein the functional layer comprises at least one microcut inorganic layer comprising:
a pattern of cut toolmarks; and
plates bounded by the toolmarks, wherein each of the plates has a thickness of about 3 nanometers to about 2000 nanometers; and
wherein the transfer article has a thickness of less than 3 micrometers.

2. The transfer article of claim 1, wherein at least a portion of the plates are free of cracks extending through a thickness thereof.

3. The transfer article of claim 1, wherein the plates comprise a substantially flat exposed surface.

4. The transfer article of claim 1, wherein the plates comprise a contoured exposed surface.

5. The transfer article of claim 1, wherein the cut toolmarks comprise substantially linear cuts, and wherein the cuts extend through a predetermined thickness of the inorganic layer.

6. The transfer article of claim 1, wherein the plates have larger dimensions in an x-y plane of the inorganic layer than in a z-direction normal to the x-y plane of the inorganic layer.

7. The transfer article of claim 6, wherein the plates are discrete and have a regular shape.

8. The transfer article of claim 7, wherein the plates have a square or rectangular shape when viewed above the x-y plane of the inorganic layer.

9. The transfer article of claim 1, wherein the plates occupy about 1% to about 99% of a surface area of the inorganic layer.

10. The transfer article of claim 1, wherein the cut toolmarks comprise substantially parallel linear cuts, and wherein the parallel linear cuts are separated by boundary regions.

11. The transfer article of claim 10, wherein the boundary regions are interconnected.

12. The transfer article of claim 11, wherein the boundary regions occupy about 1% to about 99% of a surface area of the inorganic layer.

13. The transfer article of claim 1, wherein the plates comprise rectangular prisms.

14. The transfer article of claim 13, wherein the plates have a substantially similar thickness.

15. The transfer article of claim 1, wherein the carrier layer comprises an acrylate or an acrylamide.

16. The transfer article of claim 15, wherein the carrier layer comprises an acrylate.

17. The transfer article of claim 1, further comprising a low modulus layer overlaying the functional layer, wherein the low modulus layer has a modulus of about 50 MPa to about 1000 MPa.

18. The transfer article of claim 17, wherein the low modulus layer is an adhesive layer.

19. The transfer article of claim 1, wherein the functional layer comprises a plurality of inorganic layers separated by insulating layers, and wherein at least one inorganic layer of the plurality of metal and metal oxide layers is the microcut inorganic layer.

20-33. (canceled)

34. An article, comprising:
a first acrylate layer, and
a functional layer with a first major surface on the first acrylate layer, the functional layer comprising a stack of metal layers and metal oxide layers, wherein at least one of the metal layers comprises a pattern of cuts forming a corresponding pattern of discrete plates bounded by the cuts, and wherein the precision cut metal layer is about 5 nanometers to about 100 nanometers thick, and
a second acrylate layer on a second major surface of the functional layer;
a first adhesive layer on the first acrylate layer, and a first polymeric film layer on the first adhesive layer,
a second adhesive layer on the second acrylate layer, wherein the second adhesive layer is optically clear, and a second polymeric film layer on the second adhesive layer.

35-43. (canceled)
